(19) United States
(12) Patent Application Publication
(10) Pub. No.: US 2015/0135427 A1
(43) Pub. Date: May 21, 2015

(54) BASIN

(71) Applicant: Michael Casey, Smyrna, GA (US)

(72) Inventor: Michael Casey, Smyrna, GA (US)

(21) Appl. No.: 14/542,111

(22) Filed: Nov. 14, 2014

Related U.S. Application Data
(60) Provisional application No. 61/904,686, filed on Nov. 15, 2013.

(51) Int. Cl. E03C 1/18; B28D 1/22

(52) U.S. Cl. CPC E03C 1/18; B28D 1/22
USPC 4/619; 29/416

(57) ABSTRACT

A basin manufactured from a solid slab of stone having a depth of multiple times the thickness of the original slab, which may match the naturally occurring patterns of said slab when used as a countertop, and a method of producing the same.

This patent application claims is the benefit of U.S. Provisional Patent Application No. 61/904,686 having a filing date of 15 Nov. 2013.

### BACKGROUND OF THE INVENTION

1. Technical Field

The invention is generally related to the field of natural (or artificial) stone countertops and integrated pooling sinks: specifically under-mount, top mount (vessel), and drop-in sinks. This invention is also related to the reuse of “remnant” stone material typically devalued when the hole is cut in the slab in order to place a basin. Additionally, this invention relates to the field of custom stonework, where the item produced incomparably matches the grain and patterning of another piece made from the same unique stone.

2. Related Art

High-end stone countertops are known for their beauty, ease of maintenance, and (depending on material) durability. The fact that large portions, if not the entirety, of these countertops are formed from a single slab of stone adds to these characteristics. In the case of natural stone, the patterning or veining of each slab is often unique and not readily matched.

Sinks attached to these countertops are typically made of porcelain, composite (agglomerated) granite, glass, cast iron, or stainless steel. None of the sinks made from these materials match the distinct properties of the countertop. Convex basins or sinks can be made from natural stone, but typically by carving the basin out a solid piece of stone, or by tiling small pieces of the stone together. Neither of these methods typically yields a basin that matches the distinct properties of the countertop.

Additionally, when a hole is cut in the slab to integrate the basin, the piece of slab removed becomes remnant material that is greatly devalued because of its smaller contiguous size; and therefore fewer practical applications. Accordingly, there is always a need to provide maximum utility for this remnant material.

Fairly recently, the advent of 5-axis Computer Numerical Control, known in the art as CNC, abrasive waterjet cutting machines has enabled a variety of formerly impossible shapes to be cut from materials such as stone with relative ease, expedience and affordability.

### BRIEF SUMMARY OF THE INVENTION

Briefly, the present invention is a basin or sink manufactured from one or more slabs of stone typically used in high-end countertops. The pieces of stone that make up the basin are concentric frustoconical rings of differing diameter cut from the slab at an angle through the depth of the slab, such that each shape has a first perimeter, typically the upper perimeter, that is larger than a second perimeter, typically the lower perimeter. Additionally, a 1¼″ circular hole is provided for in the center of the lowermost, or bottom, center piece, to facilitate a drain. These pieces can be cut in order from the largest, most outside piece inward, while making sure the innermost piece is supported on level with the rest of the slab to prevent the piece falling into the cut. Alternatively, these pieces can be cut in order from the smallest, most inside piece outward, the pieces are then removed from the top side of the slab. The removed pieces (with the exception of the one cut out for the drain) are then stacked such that the bottom of the widest or largest piece or ring is in contact with the top of the next widest or largest piece, and so on, with the same pitch, yaw, roll, and center relative to one another as they possessed when they were in the solid slab. The pieces are permanently affixed to one another in this configuration. As necessary, the result is then further carved (if an altered shape such a more curved surface is desired), waterproofed and polished, sealed and shined.

The result is a basin matching the distinct properties and patterning of the slab from which it was cut with the exception of any variances through the depth of the slab and the seams at intervals of the thickness of the original slab. The visual effect produced may be considered aesthetically pleasing, because the patterning of the interior and exterior of the basin shall have changed minimally from the original patterning of the slab. If desired, the basin may be affixed to the underside of the slab it came from upon installation of the countertop, forming an integrated basin that is custom made to match the countertop being installed. The basin may also be affixed from above as a drop-in sink, either to the original slab or any other slab with the same angled cut and thickness, the rim will be flush, though the depth of the basin will be lessened. Alternatively, the basin may be attached on top another surface with drain hole to function as a vessel sink. Yet another option is to drop the basin into a different surface with only one of the smaller, similarly shaped angled sections cut out, creating a drop in basin with high overhanging rim.

These and other uses, features, and advantages of the present invention will become more apparent to those of ordinary skill in the relevant art when the following detailed description of the preferred embodiments is read in conjunction with the appended figures.

### BRIEF DESCRIPTION OF THE FIGURES

FIGS. 1A, 1B, and 1C comprise three views of a first embodiment of the invention. FIG. 1A is a top-front perspective view of an embodiment of the slab structure after the cuts, in this embodiment circular, have been made. FIG. 1B is a cross-section of a top-front view of the embodiment of FIG. 1A highlighting the angles of the circular cuts through the slab. FIG. 1C is a top-front perspective of an exploded view of the embodiment in FIG. 1A showing the cut pieces of the slab as they look individually.

FIGS. 2A, 2B, 2C, and 2D comprise four views of the basin portion of a first embodiment of the invention, assembled from the pieces shown in FIG. 1. FIG. 2A is a top view of the assembled basin. FIG. 2B is a side view of the assembled basin. FIG. 2C is a top-side perspective view of the assembled basin. FIG. 2D is a top-side perspective view of the assembled basin ad a lower angle of perspective than FIG. 2C.

FIGS. 3A, 3B, and 3C comprise three views of a completed first embodiment of the invention, wherein the assembled basin is affixed to the underside of the original slab. FIG. 3A is a front view of an embodiment of the slab and under-mounted basin. FIG. 3B is a top-front perspective view of the embodiment in FIG. 3A. FIG. 3C is a top front perspective view of the embodiment in FIG. 3A, with a higher angle of perspective than FIG. 3B.

FIGS. 4A and 4B comprise two views of an embodiment of a completed second embodiment of the invention, wherein the assembled basin is lowered into the cavity into the slab, rather than being mounted to the underside as in FIG. 3. FIG. 4A is a top-front perspective view of the basin being lowered into the cavity in the slab. FIG. 4B is a top-front perspective of a completed embodiment of the invention, wherein the rim of the basin is flush with the surface of the slab.

FIGS. 5A and 5B comprise two views of a completed third embodiment of the invention, wherein the basin is affixed to a different slab to form a vessel style basin. The slab used in this embodiment has a hole cut in it to facilitate a drain. FIG. 5A is a top-front perspective view of a vessel embodiment of the invention. FIG. 5B is a bottom-front view of the embodiment in FIG. 5A.

FIG. 6 is a top-front perspective view of an embodiment of the invention wherein the basin is affixed to a different slab to form a drop-in sink with high overhanging rim. The slab used in this embodiment had had a disc removed in the shape of the third circular cut from the original slab.

FIGS. 7A and 7B comprise two views of a fourth embodiment of the invention, wherein rectangular pyramidal sections are cut from the slab; instead of the circular conic sections in FIG. 1. The resulting partial pyramidal basin is then affixed to the bottom of the slab in a similar fashion as FIG. 3. FIG. 7A is a top view of a rectangular pyramidal under-mounted embodiment. FIG. 7B is a top-front perspective view of the embodiment in FIG. 7A.

FIGS. 8A and 8B comprise two views of a fifth embodiment of the invention, wherein oval conic sections are cut from the slab; instead of the circular conic sections in FIG. 1. The resulting partial oval conic basin is then affixed to the bottom of the slab in a similar fashion as FIG. 3. FIG. 8A is a top view of an oval conic under-mounted embodiment. FIG. 8B is a top-front perspective view of the embodiment in FIG. 8A.

FIGS. 9A and 9B comprise two views of a sixth embodiment of the invention, wherein the circular basin structure in FIG. 2 is carved into a more bowl-like shape. FIG. 9A is a cross-section, side view of the embodiment showing initial state before carving and the shape to be carved. FIG. 9B is a cross-section, side view of the embodiment in FIG. 9A after having been carved onto a more bowl-like shape.

FIG. 10 is a perspective view of a round embodiment of the basin of the invention.

FIG. 11 is a side view of the basin of FIG. 10.

FIG. 12 is a top view of the basin of FIG. 10.

FIG. 13 is a perspective view of an oval embodiment of the basin of the invention.

FIG. 14 is a side view of the basin of FIG. 13.

FIG. 15 is a top view of the basin of FIG. 13.

FIG. 16 is a perspective view of a rectangular embodiment of the basin of the invention.

FIG. 17 is a side view of the basin of FIG. 16.

FIG. 18 is a top view of the basin of FIG. 16.

FIG. 19 is a top perspective view of a representative ring from which the present invention is constructed.

FIG. 20 is a side cross section of the representative ring of FIG. 19.

### DETAILED DESCRIPTION OF THE PREFERRED EMBODIMENTS

Referring now to the figures, the present invention is a basin 6, 9, 10 or sink manufactured from one or more slabs 1 of stone typically used in high-end countertops. The pieces of stone that make up the basin 6, 9, 10 are concentric frustoconical rings 2 of differing diameter cut from the slab 1 at an angle through the depth of the slab 1, such that each ring 2 has a first perimeter, typically the upper outer perimeter 14, that is larger than a second perimeter, typically the lower outer perimeter 15. Additionally, a 1¼″ circular hole 4 can be provided for in the center of the lowermost, or bottom, center piece or innermost ring 3 (also referred to as disc), to facilitate a drain. These rings 2 can be cut in order from the largest, most outside ring 2A inward, while making sure the innermost ring 3 (or sometimes 2E if innermost ring 3 is a disc) is supported on level with the rest of the slab 1 to prevent the ring 2A, 2B, 2C, 2D, 2E, 3 or rings 2 falling into the cut. The rings 2 are then removed from the top side of the slab 1.

The removed rings 2 (with the exception of the portion of the innermost ring or disc 3 cut out for the drain hole 4) are then stacked such that the bottom of the widest or largest piece or ring 2A is in contact with the top of the next widest or largest ring 2B, and so on, ring 2B on ring 2C, ring 2C on ring 2D, ring 2D on ring 2E, ring 2E on ring or disc 3, with the same pitch, yaw, roll, and center relative to one another as the rings 2 possessed when the rings 2 were in the solid slab 1. The rings 2 are permanently affixed to one another in this configuration. As necessary, the result is then further carved (if an altered shape such a more curved surface is desired), waterproofed and polished, sealed and shined.

The result is a basin 6, 9, 10 matching the distinct properties and patterning of the slab 1 from which it was cut with the exception of any variances through the depth of the slab 1 and the seams at intervals of the thickness of the original slab 1. The visual effect produced may be considered aesthetically pleasing, because the patterning of the interior and exterior of the basin 6, 9, 10 shall have changed minimally from the original patterning of the slab 1. If desired, the basin 6, 9, 10 may be affixed to the underside of the slab 1 it came from upon installation of the countertop, forming an integrated basin 6, 9, 10 that is custom made to match the countertop being installed. The basin 6, 9, 10 may also be affixed from above as a drop-in sink, either to the original slab 1 or any other slab 1 with the same angled cut and thickness, the rim will be flush, though the depth of the basin 6, 9, 10 will be lessened. Alternatively, the basin 6, 9, 10 may be attached on top another surface with drain hole 4 to function as a vessel sink. Yet another option is to drop the basin 6, 9, 10 into a different surface with only one of the smaller, similarly shaped angled sections cut out, creating a drop in basin 6, 9, 10 with high overhanging rim.

The shape of the cut on the surface of the slab 1 may be any simple or complex closed curve or polygon, with the resulting basin 6, 9, 10 being three-dimensional partial cone or pyramid projected from the original two-dimensional shape. The angle of the cut toward the center of the shape can be varied to produce steeper cuts providing more depth at the expense of wall thickness of the basin; with the inverse result for shallower cuts. Alternatively, the shape of the cut on the surface of the slab 1 may be any simple or complex open curve or polygon, with the resulting basin 6, 9, 10 being three-dimensional open sided partial cone or pyramid projected from the original two-dimensional shape. Alternatively, the shape of the cut on the surface of the slab 1 may be a combination of any simple or complex closed and open curve or polygon, with the resulting basin 6, 9, 10 being three-dimensional combined closed and open sided partial cone or pyramid projected from the original two-dimensional shape.

The rings 2 comprising the basin 6, 9, 10 can be affixed together by adhesives 18 known in the art to work well on stone. As a stone basin 6, 9, 10 is being created, the preferred cured adhesive 18 must be waterproof and able to support the weight of the stone. There are three such adhesives 18 commonly used in the art: polyurethane, cyanoacrylate (commonly known as superglue), and 2-part epoxy. Although polyurethane is an adequate adhesive for this purpose, it is considered an inferior solution by those in the art due to its relatively weak bond. Cyanoacrylate is relatively new to the art and creates by far the strongest bond. It may be used with an accelerant to greatly speed the curing process; however, the accelerant is known to stain certain types of stone. Epoxies are comprised of a resin and a hardener, and may have a coloring agent mixed in to better match the material being adhered; they currently appear to be the preferred adhesive by most familiar with the art.

Once the basin 6, 9, 10 is formed into a solid unit, it may be carved to form a more rounded carved surface 12 if so desired. Optionally, a depression 19 in the bottom may be carved to assist water flow to the drain hole 4. The interior and/or exterior surfaces of the basin 6, 9, 10 may then need to be polished prior to installation.

Any number of slabs 1 of the same thickness can be cut into the same rings 2, making any of the rings 2 from any one slab 1 interchangeable with the corresponding ring 2 of any other slab 1. This can allow one to create basins 6, 9, 10 with horizontal stripes by alternating rings 2 from two different slabs 1, or to create a pattern (for example, a rainbow pattern) by using a different ring 2 from each slab 1.

The angle 20 of the cut through the slab 1 may be varied for each ring 2. In one embodiment, the angle 20 will start out relatively steep and grow shallower with each ring 2 cut toward the center ring 2E, 3. The effect is to produce a basin 6, 9, 10 with a more bowl-like shape than a partial cone. This embodiment will or may leave extra material on the outside of the basin 6, 9, 10 that must be removed if a smooth uniform exterior surface is desired.

Often, basins 6, 9, 10 are equipped with an overflow drain. The simplest way to achieve this functionality would be to cut at least one overflow drain hole 21 near the upper rim of the basin 6, 9, 10 and mount a drain to them externally. Alternatively, the overflow drain holes 21 could be cut in the concentric ring 2 in such a way that when the basin 6, 9, 10 is assembled, they create a drain path 24 from near the upper rim through the stone of the basin 6, 9, 10 itself. Such holes would be cut in the direction from the upper surface 22 of each ring 2 through the body of the ring 2 to the lower surface 23 of each ring 2. The holes through each ring 2 then would have to be made so that the holes align so as to form the drain path 24.

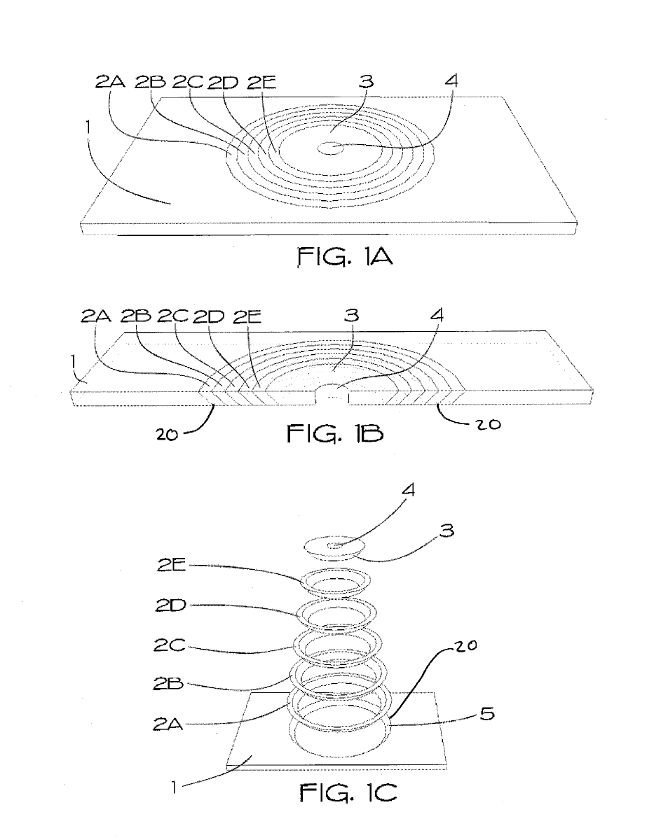

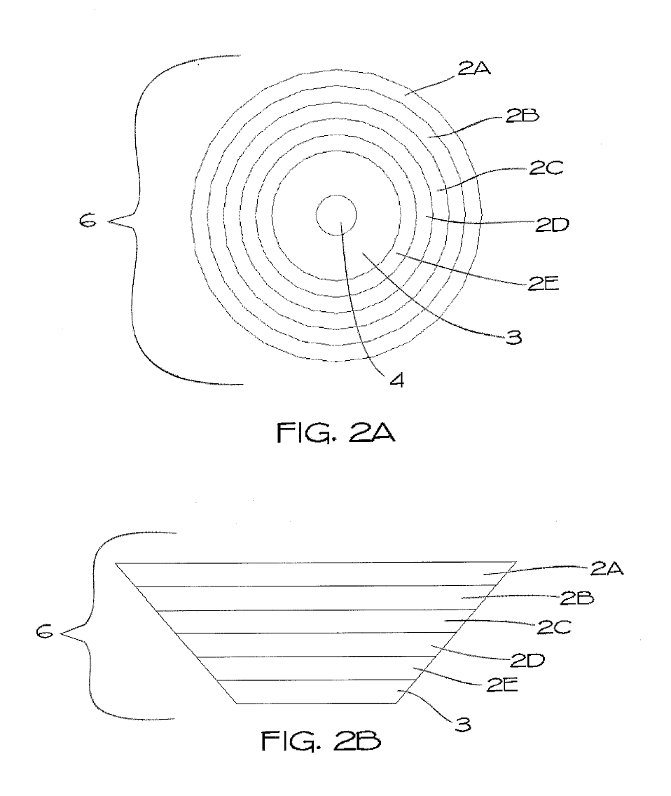

FIGS. 1A, 1B, and 1C comprise three views of a first embodiment of the invention.

FIG. 1A is a top-front perspective view of an embodiment of a solid slab 1 of natural or other solid surface countertop material 1 in which concentric conic section rings 2 with cut at an angle 20 through the slab 1 towards the center 2A-2E have been cut. Interior to the innermost conic section ring 2E, a disc 3 is cut with outer edge angled toward the center in a supplementary manner to the innermost edge of the innermost conic section ring 2E. In the center of the disc 3 a cylindrical hole 4 is cut.

FIG. 1B is a cross-section of a top-front view of the embodiment of FIG. 1A highlighting the angles of the cuts of the circular conic section rings 2A-2E through the slab 1. Also displayed is interior disc 3 with cylindrical hole 4.

FIG. 1C is a top-front perspective of an exploded view of the embodiment in FIG. 1 showing the rings 2: concentric conic section rings 2A-2E; interior disc 3 with cylindrical hole 4; individually after they have been removed from the slab 1 with interior angled cut edge 5 which is supplementary to the exterior angle of the outermost conic section ring 2A as all pieces look individually.

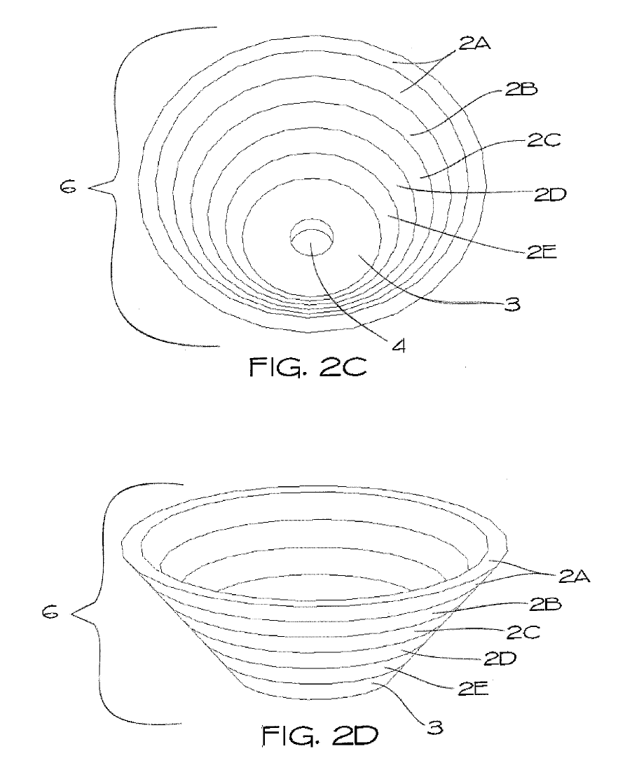

FIGS. 2A, 2B, 2C, and 2D comprise four views of the assembled basin 6 portion of a first embodiment of the invention, assembled from the rings 2, 3 shown in FIGS. 1A, 1B, and 1C. In which, the concentric rings 2A-2E, are affixed to one another with the bottom of each concentric conic section ring (example, ring 2A) adjoining the top of the next smaller conic section ring (example ring 2B) for all conic ring 2 sections. The bottom of the smallest conic section ring 2E is affixed to the top of the interior disc 3 having cylindrical hole 4.

FIG. 2A is a top view of the assembled basin 6 comprised of conic section rings 2A-2E and interior disc 3 having cylindrical hole 4.

FIG. 2B is a side view of the assembled basin 6 comprised of conic section rings 2A-2E and interior disc 3. Adhesive 18 is located between rings 2 so as to form a unitary basin 6, 9, 10.

FIG. 2C is a top-side perspective view of the assembled basin 6 comprised of conic section rings 2A-2E and interior disc 3 having cylindrical hole 4.

FIG. 2D is a top-side perspective view of the assembled basin 6 comprised of conic section rings 2A-2E and interior disc 3.

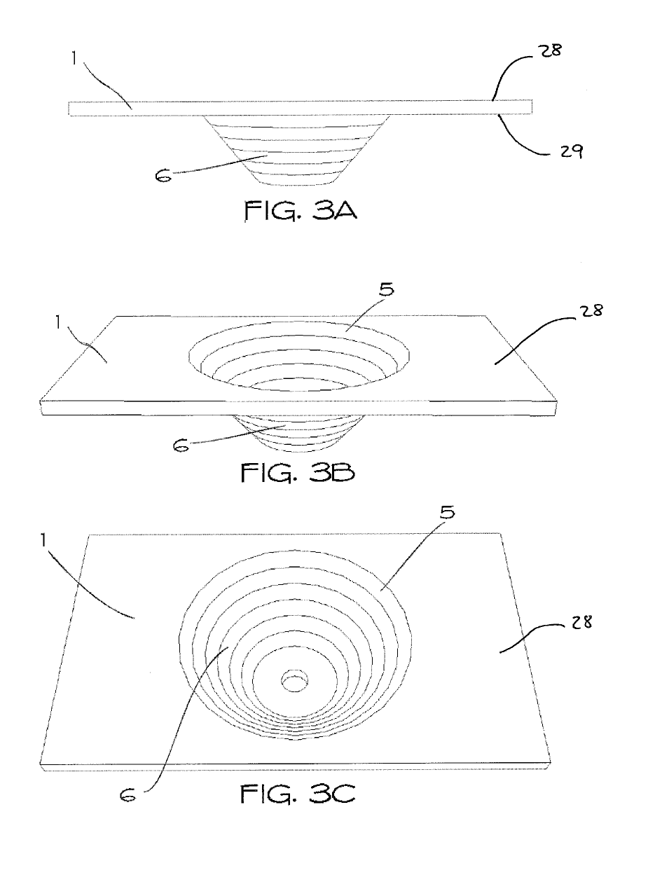

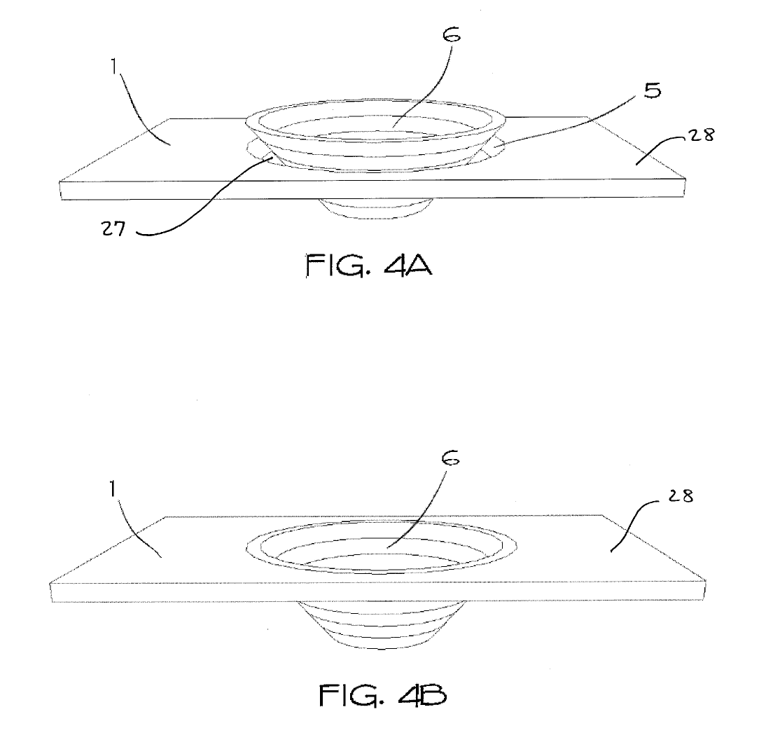

FIGS. 3A, 3B, and 3C comprise three views of a completed first embodiment of the invention, wherein the assembled basin 6 is affixed to the underside or bottom surface 29 of the original slab 1, having interior angled edge 5. As the angled edge 5 of slab 1 has the same slope as the interior of the basin 6 the effect of the embodiment is to appear such that basin 6 is protruding from slab 1. In one such embodiment, slab 1 may be the original slab that the rings 2, 3 comprising basin 6 came from, in which case the distinctive patterning of the stone of the slab 1 will closely match that of the basin 6, contributing to the perception of basin 6 being an actual protrusion of slab 1. In an alternate embodiment, slab 1 may be a different but similarly shaped slab 1 so as to provide visual contrast to basin 6. This embodiment is commonly known in the art as an “under-mount” basin.

FIG. 3A is a front view of an embodiment, comprised of slab 1 and under-mounted basin 6.

FIG. 3B is a top-front perspective view of the embodiment in FIG. 3A, comprised of slab 1 and under-mounted basin 6. The inner edge 5 of slab 1 is aligned with the interior of the basin 6.

FIG. 3C is a top-front perspective view of the embodiment in FIG. 3A, comprised of slab 1 and under-mounted basin 6, with a higher angle of perspective than FIG. 3B. The inner edge 5 of slab 1 is aligned with the interior of the basin 6.

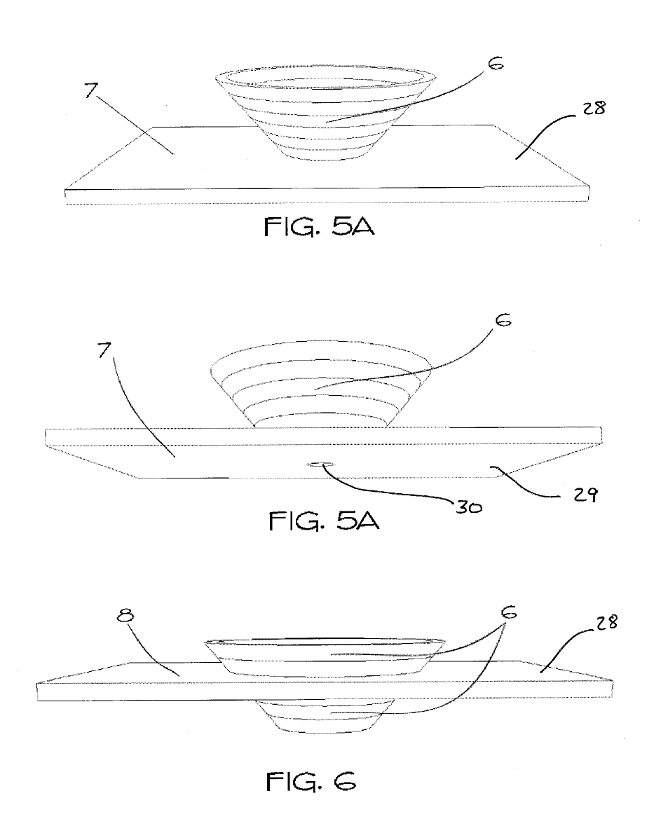

FIGS. 4A and 4B comprise two views of an embodiment of a completed second embodiment of the invention, wherein the assembled basin 6 is lowered into the cavity 27 into the slab 1, rather than being mounted to the underside as in FIGS. 3A, 3B, and 3C. This embodiment represents what is commonly known as a “drop-in” basin in the art.

FIG. 4A is a top-front perspective view of the basin 6 being lowered into the cavity 27 in the slab 1. The interior angled cut 5 of slab 1 is the same slope as and aligns with the exterior of basin 6.

FIG. 4B is a top-front perspective of a completed embodiment of the invention, wherein the rim of basin 6 is flush with the top surface 28 of the slab 1. The hidden inner edge 5 of slab 1 (shown in FIG. 4A) is flush with and affixed to the outer edge of basin 6.

FIG. 5 comprises two views of a completed third embodiment of the invention, wherein the basin 6 is affixed to a different slab 7. The slab 7 used in this embodiment is necessarily different from the original slab 1 (FIGS. 1A, 1B, and 1C) because it must not have a cavity 27 like the one caused by removal of rings 2A-2F and 3 (FIGS. 1A, 1B, and 1C). The slab 7 has a hole 30 cut in it to facilitate a drain. This embodiment is commonly known in the art as a “vessel” style basin.

FIG. 5A is a top-front perspective view of a vessel embodiment of the invention, wherein the bottom of basin 6 is affixed to the top surface 28 of slab 7.

FIG. 5B is a bottom-front view of the embodiment in FIG. 5A, wherein the bottom of basin 6 is affixed to the top surface 28 of slab 7.

FIG. 6 is a top-front perspective view of an embodiment of the invention wherein the basin 6 is affixed to a different slab 8 to form a drop-in sink with high overhanging rim. The slab 8 used in this embodiment had had a disc removed in the shape of the third circular conic section 2C (FIGS. 1A, 1B, and 1C) from the original slab.

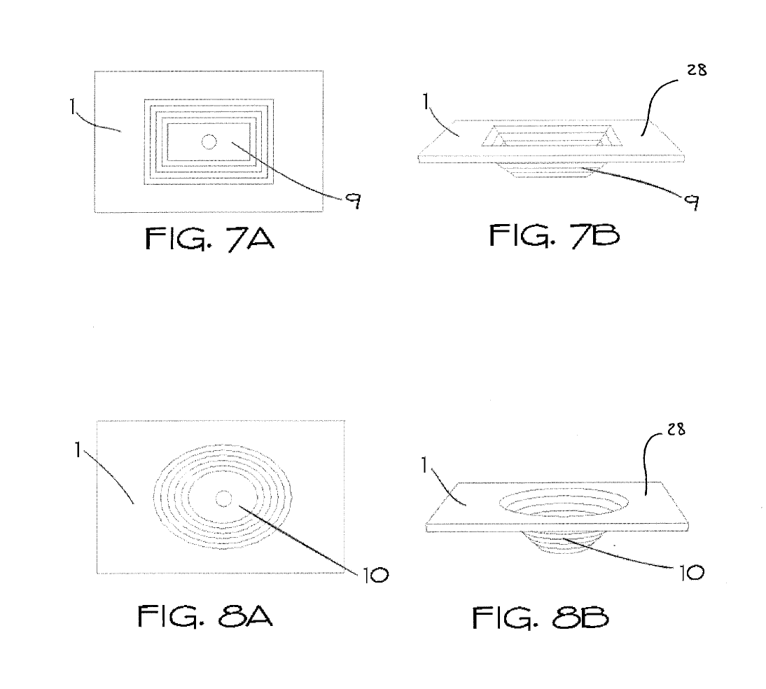

FIGS. 7A and 7B comprise two views of a fourth embodiment of the invention, wherein rectangular pyramidal sections are cut from the slab 1; instead of the circular conic sections in FIGS. 1A, 1B, and 1C. The resulting partial pyramidal basin 9 is then affixed to the bottom surface 29 of the slab 1 in a similar fashion as FIGS. 3A, 3B, and 3C. In this embodiment a rectangle is displayed; however, any arbitrary polygonal shape may be formed into the projected basin 6, 9, 10.

FIG. 7A is a top view of rectangular pyramidal basin 9 under-mounted to slab 1.

FIG. 7B is a top-front perspective view of rectangular pyramidal basin 9 under-mounted to slab 1.

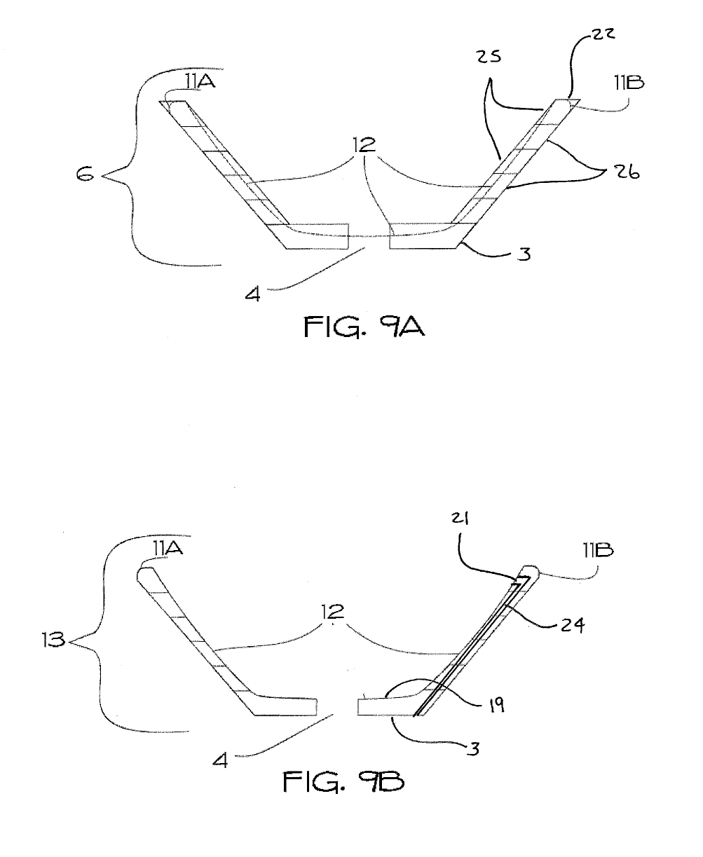

FIGS. 8A and 8B comprise two views of a fifth embodiment of the invention, wherein oval conic sections are cut from the slab instead of the circular conic sections in FIGS. 1A, 1B, and 1C. The resulting partial oval conic basin 6 is then affixed to the bottom surface 29 of slab 1 in a similar fashion as FIGS. 3A, 3B, and 3C. In this embodiment an oval is displayed, however, any arbitrary simple closed-curve shape may be formed into the projected basin 6, 9, 10.

FIG. 8A is a top view of an oval conic basin 10 under-mounted to slab 1.

FIG. 8B is a top-front perspective view of basin 10 under-mounted to slab 1.

FIGS. 9A and 9B comprises two views of a sixth embodiment of the invention, wherein the circular basin structure 6 in FIGS. 2A, 2B, 2C, and 2D is carved into a more bowl-like shape 13.

FIG. 9A is a cross-section, side view of the embodiment showing initial state of the basin 6 before carving and the exterior 11A-11B and interior 12, 19 shapes to be carved. The drain hole 4 is represented by the gap in the middle of the bottom.

FIG. 9B is a cross-section, side view of the embodiment in FIG. 9A after the basin having been carved onto a more bowl-like shape 13, by means of the exterior carving 11A-11B and interior carving 12, 19. The drain hole 4 is represented by the gap in the middle of the bottom.

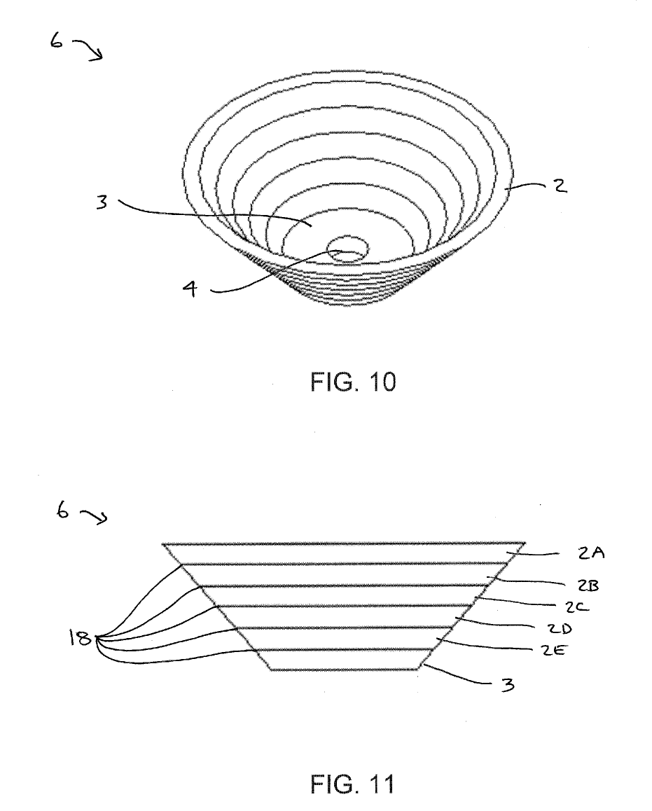

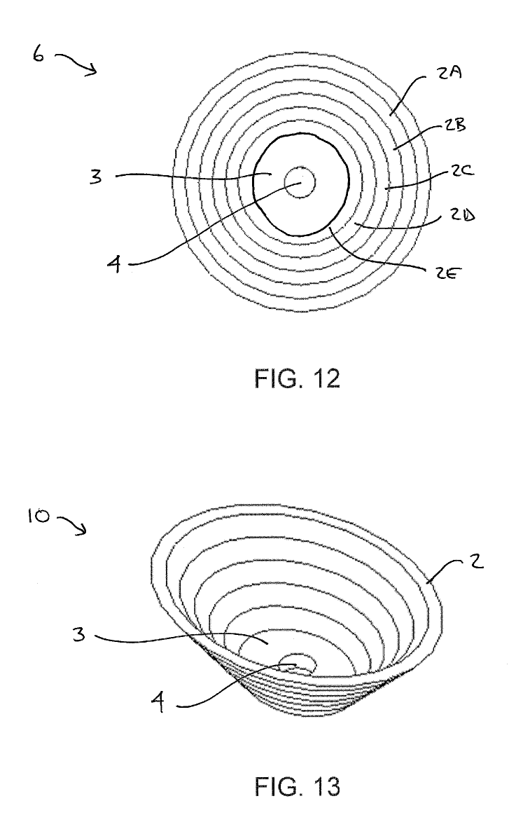

FIG. 10 is a perspective view of a round embodiment of the basin 6 of the present invention such as shown in FIGS. 2A and 2B. FIG. 11 is a side view of the basin of FIG. 10. FIG. 12 is a top view of the basin of FIG. 10.

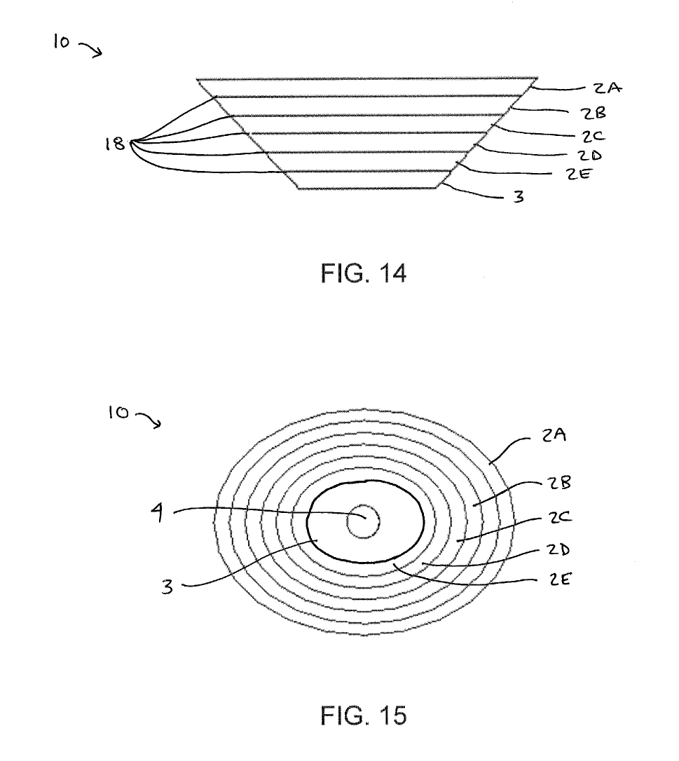

FIG. 13 is a perspective view of an oval embodiment of the basin 10 of the present invention such as shown in FIGS. 8A and 8B. FIG. 14 is a side view of the basin of FIG. 13. FIG. 15 is a top view of the basin of FIG. 13.

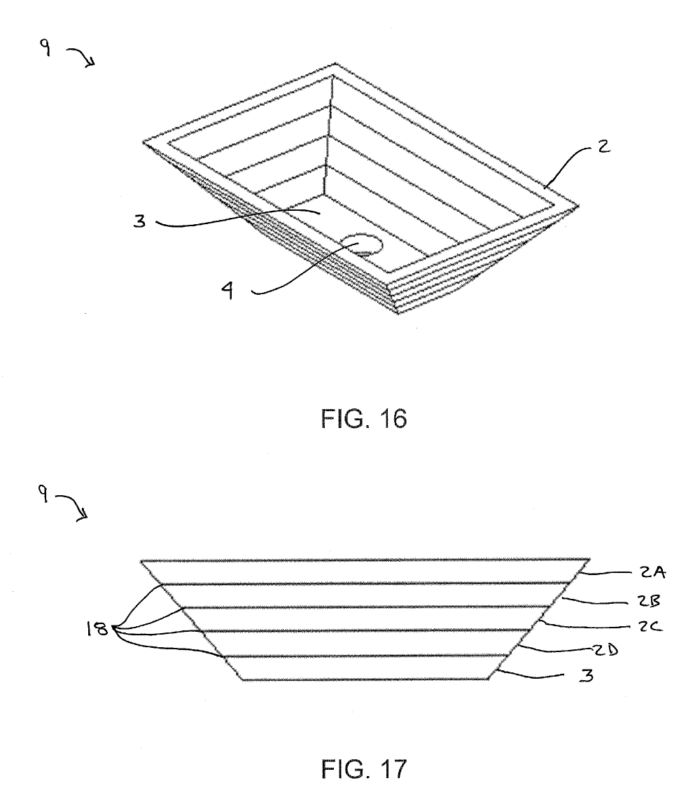

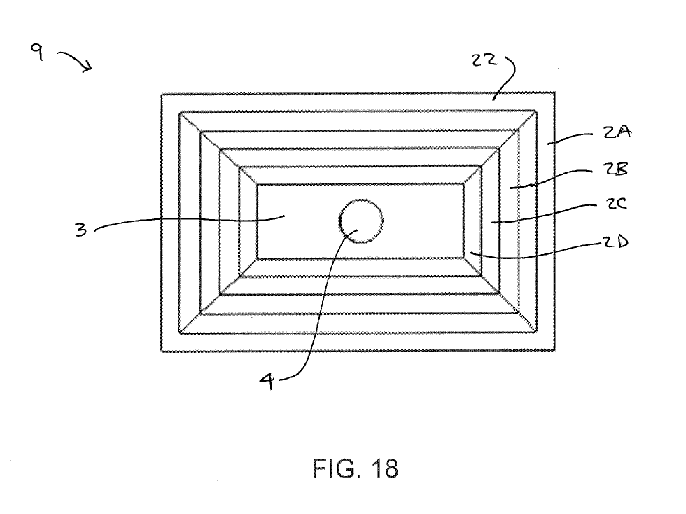

FIG. 16 is a perspective view of a rectangular embodiment of the basin 9 of the present invention such as shown in FIGS. 7A and 7B. FIG. 17 is a side view of the basin of FIG. 16. FIG. 18 is a top view of the basin of FIG. 16.

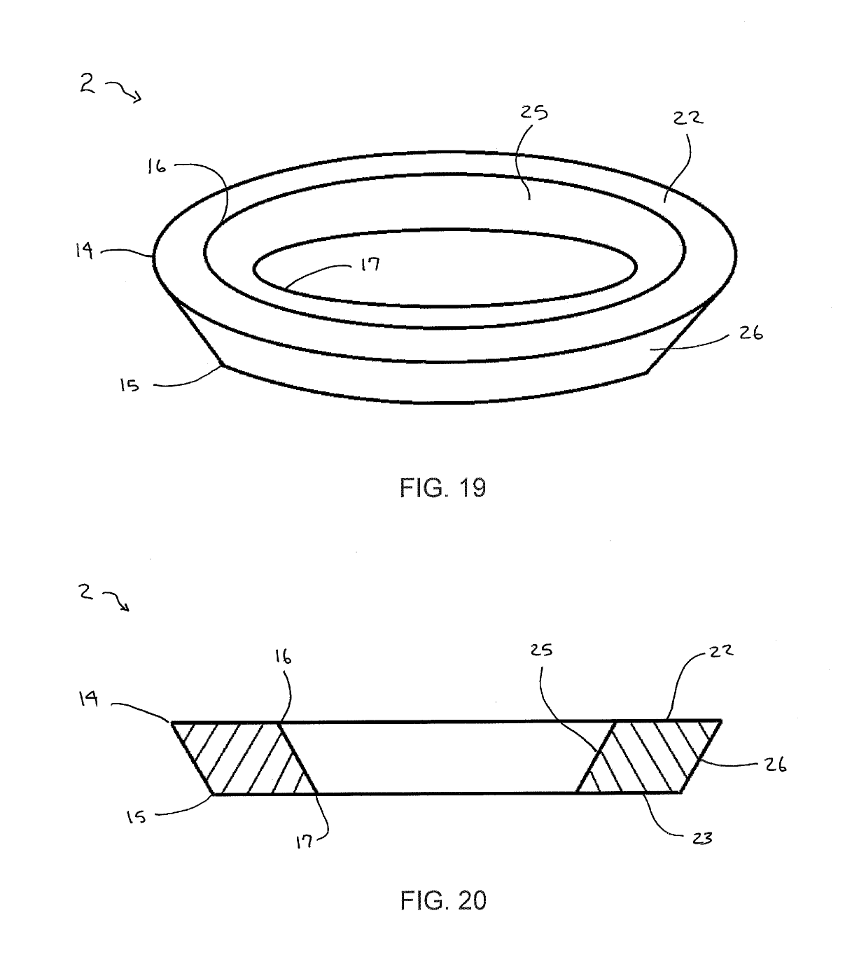

FIG. 19 is a top perspective view of a representative ring 2 from which the present invention is constructed for illustrating the various features of the rings 2. FIG. 20 is a side cross section of the representative ring 2 of FIG. 19.

A preferred embodiment of the method for making a basin 6, 9, 10 according to the present invention comprises the steps of (a) cutting progressively larger rings 2 from at least one slab 1 of material and (b) stacking the rings 2 on top of each other, forming a stack of rings 2A, 2B, 2C, 2D, 2E, to form the basin 6, 9, 10, wherein (1) the rings 2 comprise a flat top surface 22 and a flat bottom surface 23 parallel to each other, (2) the rings 2 comprise an inner surface 25 and an outer surface 26, each of which extends between the top surface 22 and the bottom surface 23, (3) the top surface 22 has a first top perimeter 16 at a junction of the top surface 22 and the inner surface 25 and a second top perimeter 14 at a junction of the top surface 22 and the outer surface 26, (4) the bottom surface 23 has a first bottom perimeter 17 at a junction of the bottom surface 23 and the inner surface 25 and a second bottom perimeter 15 at a junction of the bottom surface 23 and the outer surface 26, (5) the inner surface 25 forms an angle between 0 and 90 degrees, but not 0 or 90 degrees, to the bottom surface 23 and a supplementary angle between 90 and 180 degrees, but not 90 or 180 degrees, to the top surface 22, and (6) the outer surface 26 forms an angle between 0 and 90 degrees, but not 0 or 90 degrees, to the top surface 22 and a supplementary angle between 90 and 180 degrees, but not 90 or 180 degrees, to the bottom surface 23, whereby the first bottom perimeter 17 of a first ring 2 (for example ring 2C) is smaller than the second top perimeter 14 of a second ring 2 (for example ring 2D) located immediately below the first ring 2 in the stack of rings 2A, 2B, 20, 2D, 2E.

A preferred embodiment of the basin 6, 9, 10 of the present invention is formed from progressively larger rings 2E, 2D, 2C, 2B, 2A cut from at least one slab 1 of material, the rings 2 being stacked on top of each other, forming a stack of rings 2A, 2B, 2C, 2D, 2E, wherein (1) the rings 2 comprise a flat top surface 22 and a flat bottom surface 23 parallel to each other, (2) the rings 2 comprise an inner surface 25 and an outer surface 26, each of which extends between the top surface 22 and the bottom surface 23, (3) the top surface 22 has a first top perimeter 16 at a junction of the top surface 11 and the inner surface 25 and a second top perimeter 14 at a junction of the top surface 11 and the outer surface 26, (4) the bottom surface 23 has a first bottom perimeter 17 at a junction of the bottom surface 23 and the inner surface 25 and a second bottom perimeter 15 at a junction of the bottom surface 23 and the outer surface 26, (5) the inner surface 25 forms an angle between 0 and 90 degrees, but not 0 or 90 degrees, to the bottom surface 23 and a supplementary angle between 90 and 180 degrees, but not 90 or 180 degrees, to the top surface 22, and (6) the outer surface 26 forms an angle between 0 and 90 degrees, but not 0 or 90 degrees, to the top surface 22 and a supplementary angle between 90 and 180 degrees, but not 90 or 180 degrees, to the bottom surface 23, whereby the first bottom perimeter 17 of a first ring 2 (for example ring 20) is smaller than the second top perimeter 14 of a second ring 2 (for example ring 2D) located immediately below the first ring 2 in the stack of rings 2A, 2B, 2C, 2D, 2E.

In order to construct a basin 6, 9, 10 with angled sides, the cuts preferably are made so that the inner surface 25 forms an angle between 10 and 85 degrees, and more preferably between 30 and 80 degrees, to the bottom surface 23 and a supplementary angle between 80 and 175 degrees, and more preferably between 100 and 170 degrees, to the top surface 22, and the outer surface 26 forms an angle between 10 and 85 degrees, and more preferably between 30 and 80 degrees, to the top surface 22 and a supplementary angle between 80 and 175 degrees, and more preferably between 100 and 170 degrees, to the bottom surface 23.

The rings 2 can be cut concentrically to each other from the same slab 1 of material or from at least two different slabs 1 of material.

A disc 3 can be cut from the slab 1 of material to be used as the base of the basin 6, 9, 10. A circular hole 4 is provided for in the disc 3 to facilitate a drain. The disc 3 also can be considered the innermost ring.

The rings 2 can be cut in order from a largest, most outside ring 2A inward, while making sure an inner piece, disc 3 for example, is supported on level with the rest of the slab 1 of material to prevent the inner piece 3 falling into the cut. The rings 2 can be removed from a top side or surface 28 of the slab 1 of material. The rings 2 alternatively can be cut in order from a smallest, most inside ring 2E or 3 outward, and removing each of the rings 2 after the respective ring 2 is cut.

The rings 2 can be permanently affixed to one another in a stacked configuration. The stacked configuration of rings 2 can be finished using a finishing technique selected from the group consisting of waterproofing, polishing, sealing, shining, carving, and combinations thereof.

As can be seen from the figures, the rings 2 are not necessarily circular in shape, but can be any shape, such as oval, rectangular, square, triangular, or any regular or non-regular polygon. Alternatively, the rings 2 can be open shapes such as “V” shapes, “U” shapes, half circles, arcs, three-sided open ended shapes, or multi-sided open ended shapes, which, when stacked, would result in a basin 6, 9, 10 or structure having an open side. Alternatively, the rings 2 can be a combination of closed shapes and open shapes, which, when stacked, would result in a partially open sided basin 6, 9, 10 such as, for example, a basin 6, 9, 10 with a closed sided lower portion and an open sided upper portion. Therefore, the term ring 2 as used herein is used in a general manner to refer to the pieces cut from the slab 1 to be stacked into the final basin 6, 9, 10.

The cutting of the slab 1 can be accomplished by any of the known cutting methods, which include, inter alia, water jet cutters, abrasive jet cutters, oil jet cutters, mechanical saws, power saw, wet saws, and lasers.

The foregoing detailed description of the preferred embodiments and the appended figures have been presented only for illustrative and descriptive purposes and are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

### LIST OF REFERENCE NUMERALS

1 solid slab of natural stone or other solid surface countertop material
2 concentric conic section rings with cut at an angle through the slab towards the center
2A outermost (largest) ring
2B ring
2C ring
2D ring
2E ring
3 innermost (smallest) ring or disc with outer edge cut at an angle toward the center
4 hole cut in disc to facilitate a drain
5 inside edge of slab complimenting outside edge of outermost conic section ring
6 assembled circular basin structure
7 separate slab of stone or other material with a hole cut to facilitate a drain
8 separate slab of stone other material with a disc removed in the same shape as the outer edge of one of the concentric rings
9 assembled basin structure comprised of rectangular pyramidal sections
10 assembled basin structure comprised of oval rings
11 outline of a shape carved into the interior of the assembled basin, with the carving gives the basin a more bowl-like shape, lessens the sharp angles that can trap particulate and may slope downward toward the drain.
12 carved surface that is an outline of a shape carved into the exterior of the assembled basin, which may dull the sharp edges and/or improve the aesthetic of the basin.
13 assembled circular basin structure having additionally been carved into a more bowl-like shape.
14 upper outer perimeter or second top perimeter of ring
15 lower outer perimeter or second bottom perimeter of ring
16 upper inner perimeter or first top perimeter of ring
17 lower inner perimeter or first bottom perimeter of ring
18 adhesive
19 depression in the bottom of the basin
20 angle of the cut through the slab
21 overflow drain hole
22 top or upper surface of ring
23 bottom or lower surface of ring
24 drain path
25 inner surface of ring
26 outer surface of ring
27 cavity in slab
28 top side or surface of the slab
29 bottom side or surface of the slab
30 hole cut in slab to facilitate drain

What is claimed is:

1. A method for making a basin comprising the steps of:
a) cutting progressively larger rings from at least one slab of material; and
b) stacking the rings on top of each other, forming a stack of rings, to form the basin,
wherein:
the rings comprise a flat top surface and a flat bottom surface parallel to each other;
the rings comprise an inner surface and an outer surface, each of which extends between the top surface and the bottom surface;
the top surface has a first top perimeter at a junction of the top surface and the inner surface and a second top perimeter at a junction of the top surface and the outer surface;
the bottom surface has a first bottom perimeter at a junction of the bottom surface and the inner surface and a second bottom perimeter at a junction of the bottom surface and the outer surface;
the inner surface forms an angle between 0 and 90 degrees, but not 0 or 90 degrees, to the bottom surface and a supplementary angle between 90 and 180 degrees, but not 90 or 180 degrees, to the top surface; and
the outer surface forms an angle between 0 and 90 degrees, but not 0 or 90 degrees, to the top surface and a supplementary angle between 90 and 180 degrees, but not 90 or 180 degrees, to the bottom surface,
whereby the first bottom perimeter of a first ring is smaller than the second top perimeter of a second ring located immediately below the first ring in the stack of rings.

2. The method as claimed in claim 1, wherein the rings are cut concentrically to each other from the same slab of material.

3. The method as claimed in claim 1, wherein the rings are concentric with each other and are cut from at least two different slabs of material.

4. The method as claimed in claim 2, wherein a disc cut from the slab of material is used as the base of the basin.

5. The method as claimed in claim 3, wherein a disc cut from the slab of material is used as the base of the basin.

6. The method as claimed in claim 4, wherein a circular hole is provided for in the disc to facilitate a drain.

7. The method as claimed in claim 1, further comprising cutting the rings in order from a largest, most outside ring inward, while making sure an inner piece is supported on level with the rest of the slab of material to prevent the inner piece falling into the cut.

8. The method as claimed in claim 7, further comprising removing the rings from a top side of the slab of material.

9. The method as claimed in claim 1, further comprising cutting the rings in order from a smallest, most inside ring outward, and removing each of the rings after the respective ring is cut.

10. The method as claimed in claim 1, further comprising permanently affixing the rings to one another in a stacked configuration.

11. The method as claimed in claim 10, further comprising finishing the stacked configuration using a finishing technique selected from the group consisting of waterproofing, polishing, sealing, shining, carving, and combinations thereof.

12. A basin formed from progressively larger rings cut from at least one slab of material, the rings being stacked on top of each other, forming a stack of rings, wherein:
the rings comprise a flat top surface and a flat bottom surface parallel to each other;
the rings comprise an inner surface and an outer surface, each of which extends between the top surface and the bottom surface;
the top surface has a first top perimeter at a junction of the top surface and the inner surface and a second top perimeter at a junction of the top surface and the outer surface;
the bottom surface has a first bottom perimeter at a junction of the bottom surface and the inner surface and a second bottom perimeter at a junction of the bottom surface and the outer surface;
the inner surface forms an angle between 0 and 90 degrees, but not 0 or 90 degrees, to the bottom surface and a supplementary angle between 90 and 180 degrees, but not 90 or 180 degrees, to the top surface; and
the outer surface forms an angle between 0 and 90 degrees, but not 0 or 90 degrees, to the top surface and a supplementary angle between 90 and 180 degrees, but not 90 or 180 degrees, to the bottom surface,
whereby the first bottom perimeter of a first ring is smaller than the second top perimeter of a second ring located immediately below the first ring in the stack of rings.

13. The basin as claimed in claim 12, wherein the rings are cut concentrically to each other from the same slab of material.

14. The basin as claimed in claim 12, wherein the rings are concentric with each other and are cut from at least two different slabs of material.

15. The basin as claimed in claim 13, further comprising a disc cut from the slab of material used as the base of the basin.

16. The basin as claimed in claim 14, wherein a disc cut from the slab of material is used as the base of the basin.

17. The basin as claimed in claim 12, wherein

18. The basin as claimed in claim 15, wherein a circular hole is provided for in the disc to facilitate a drain.

19. The basin as claimed in claim 12, wherein the rings are permanently affixed to one another in a stacked configuration.

20. The basin as claimed in claim 19, wherein the stacked configuration is further finished using a finishing technique selected from the group consisting of waterproofing, polishing, sealing, shining, carving, and combinations thereof.
